(19) United States
(12) Patent Application Publication
(10) Pub. No.: US 2020/0038958 A1
(43) Pub. Date: Feb. 6, 2020

(54) Method and System for Compaction for Three-Dimensional (3D) Printing

(71) Applicant: Desktop Metal, Inc., Burlington, MA (US)

(72) Inventor: Andrew E. Kuklinski, Arlington, MA (US)

(21) Appl. No.: 16/051,108

(22) Filed: Jul. 31, 2018

(51) Int. Cl. B22F 3/16; B22F 3/18; B22F 1/00

(52) U.S. Cl. CPC B22F 3/16; B22F 3/18; B33Y 10/00; B22F 2998/10; B22F 1/0059

(57) ABSTRACT

A system and corresponding method for additive manufacturing of a three-dimensional (3D) object to improve uniformity of powder packing density of a powder bed used in the manufacturing process. An embodiment of the system comprises means for rotating at least one compaction roller in a first direction to produce a compacted amount of unbound powder metered onto a top surface of a powder bed and means for rotating the at least one compaction roller in a second direction, opposite of the first direction, to compact the compacted amount further, to enable higher density packing of the powder. Such higher density packing leads to better mechanical interlocking of particles, leading to lower sintering temperatures and reduced deformation of the 3D object during sintering. The uniform packing density enables uniform shrinkage, without warping, of the 3D object during sintering to produce higher quality 3D printed objects.

### BACKGROUND

Binder jetting is an additive manufacturing technique based on the use of a liquid agent to join particles of a powder material to form a three-dimensional (3D) object. In particular, a controlled pattern of the liquid agent may be applied to successive layers of the powder material in a powder bed such that the layers of the powder material adhere to one another to form the 3D object. Through subsequent processing, such as sintering, the 3D object may be formed into a finished object that may be referred to as a finished 3D part.

### SUMMARY

According to an example embodiment, a system for additive manufacturing of a three-dimensional (3D) object may comprise a multistage compaction apparatus including at least one compaction roller, a printing apparatus, and a controller. The at least one compaction roller may be configured, in a first stage, to rotate in a first direction to produce a compacted amount of unbound powder metered onto a top surface of a powder bed and, in a second stage, to rotate in a second direction, opposite the first direction, to compact the compacted amount further and form a compacted layer of the unbound powder with substantially uniform packing density and thickness across the top surface of the powder bed. The printing apparatus is configured to jet fluid into the compacted layer. The controller may be configured to drive the multistage compaction apparatus to produce the compacted layer and successive compacted layers of the powder bed with the substantially uniform packing density and thickness and drive the printing apparatus to jet fluid into compacted layers of the powder bed to print the 3D object.

The system may further comprise a metering apparatus. The controller may be further configured to: drive the multistage compaction apparatus to traverse the top surface of the powder bed in a direction of travel; and drive the metering apparatus to meter the unbound powder onto the top surface of the powder bed ahead of traversal of the multistage compaction apparatus in the direction of travel.

The controller may be further configured to drive the at least one compaction roller to rotate in the first direction to cause an active motion of the unbound powder, metered onto the top surface of the powder bed, to compact itself and produce the compacted amount.

The controller may be further configured to drive the at least one compaction roller to rotate in the second direction, opposite the first direction, to apply a downward pressure to compress the compacted amount and compact the compacted amount further.

The at least one compaction roller may be a single compaction roller, and the first and second stages may be activated sequentially.

The at least one compaction roller may include a first compaction roller and a second compaction roller. The controller may be further configured to, in the first stage, drive the first compaction roller to rotate in the first direction, and, in the second stage, drive the second compaction roller to rotate in the second direction, opposite the first direction. The first and second stages may be activated concurrently.

The system may further comprise a motor. The controller may be further configured to: in the first stage, drive the motor to cause the at least one compaction roller to rotate in the first direction to slip, relative to the unbound powder metered onto the top surface of the powder bed, to cause an active motion of the unbound powder to compact itself; and, in the second stage, drive the motor to cause the at least one compaction roller to rotate in the second direction, opposite the first direction, to cause the at least one compaction roller to spin, such that there is no slip of the at least one compaction roller relative to the compacted amount, to apply a downward pressure to the compacted amount.

The controller may be further configured, in the first stage, to drive the at least one compaction roller to rotate in the first direction around a first axis; and, in the second stage, to drive the at least one compaction roller to rotate in the second direction around a second axis, the first axis located at a distance above the second axis.

The distance may be configured based on a particle size of particles of the unbound powder.

The distance may be configured to be less than a diameter of the at least one compaction roller configured to rotate in the first direction in the first stage.

The controller may be further configured, in the first and second stages, to drive the multistage compaction apparatus to traverse the top surface of the powder bed in a direction of travel. The controller may be further configured, in the first stage, to drive rotation of the at least one compaction roller such that a rotatably changing top surface of the at least one compaction roller is configured to rotate opposite the direction of travel. The controller may be further configured, in the second stage, to drive rotation of the at least one compaction roller such that the rotatably changing top surface is configured to rotate in the direction of travel.

The substantially uniform packing density and thickness may be substantially uniform along an x, y, or z-axis, or a combination thereof.

Alternative method embodiments parallel those described above in connection with the example system embodiment.

According to yet another embodiment, an apparatus for additive manufacturing of a three-dimensional (3D) object may comprise means for rotating at least one compaction roller in a first direction to produce a compacted amount of unbound powder metered onto a top surface of a powder bed; means for rotating the at least one compaction roller in a second direction, opposite of the first direction, to compact the compacted amount and form a compacted layer of the unbound powder with a substantially uniform packing density and thickness across the top surface of the powder bed; means for jetting fluid into the compacted layer; and means for controlling the rotating of the at least one compaction roller in the first and second directions to produce the compacted layer and successive compacted layers of the powder bed with the substantially uniform packing density and thickness and controlling the jetting of the fluid into compacted layers of the powder bed to print the 3D object.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a portion of a system for additive manufacturing of a three-dimensional (3D) object.

FIG. 1B is a block diagram of an example embodiment of a system for additive manufacturing of a 3D object.

FIG. 2 is a block diagram of an example embodiment of a multistage compaction apparatus.

FIG. 3 is a flow diagram of an example embodiment of a method for additive manufacturing of a 3D object.

FIG. 4 is a block diagram of an example embodiment of a powder bed.

FIG. 5 is a block diagram of an example embodiment of a compaction roller and tangential direction of travel.

FIG. 6 is a block diagram of an example internal structure of a computer in which various embodiments of the present disclosure may be implemented.

### DETAILED DESCRIPTION

A description of example embodiments follows.

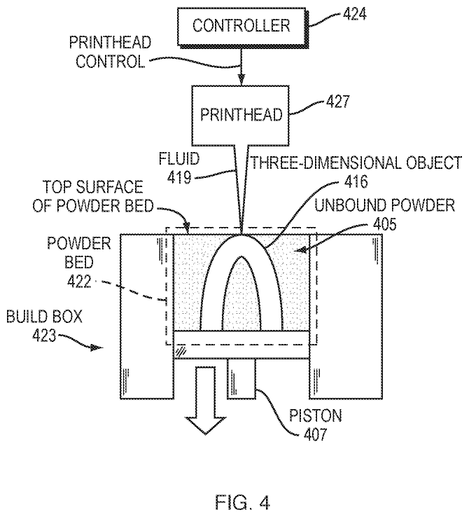

In a binder jetting process for additive manufacturing, also referred to interchangeably herein as three-dimensional (3D) printing, a thin (e.g., 50 μm) layer of unbound powder, also referred to interchangeably herein as powder or powder material, may be spread onto a powder bed, such as the powder bed disclosed further below with reference to FIG. 4, that may be composed of one or more layers of powder or an area for spreading an initial layer of powder. Spreading of the thin layer of powder may be followed by deposition of a liquid agent in a two-dimensional (2D) pattern or image that represents a single “slice” of a 3D shape representing a 3D object (also referred to interchangeably herein as a 3D part). The liquid agent may be a liquid binder. Alternatively, the powder may be coated with a binder and the liquid agent may be a liquid that activates the binder coating. The liquid agent may include 2-part binders that react on contact or may include ultraviolet (UV)-curable binders. The liquid agent may be any liquid applied with the intent to bind the powder on its own or as a result of a resulting reaction with another substance or activation energy source.

Following deposition of the liquid, another layer of powder may be spread, and the process may be repeated to form the 3D shape composed of bound material, also referred to herein as a bound part, inside the powder bed. After printing, the bound part may be removed from the powder bed, leaving behind excess powder that was not bound during the process, and the bound part thereafter may be sintered at high temperature. The sintering may be performed to “densify” the bound part to full density (i.e., removal of all void space) or may be performed to bind the particles only lightly without substantial removal of void space.

During spreading of powder, it may be useful to have the powder fill to a high density (tighter packing of the particles) as this translates to lower shrinkage because less void space needs to be removed. Higher density packing of the powder may lead to better mechanical interlocking of particles, leading to lower sintering temperatures, and reduced slumping (deformation due to gravity) during sintering. Additionally, it may be useful to have the powder packing density be substantially uniform to allow substantially uniform shrinkage of the bound part during sintering, without warping.

During powder spreading, non-uniformity of powder packing density in the powder bed may result from non-uniform spreading, packing, etc. During subsequent processing (e.g., sintering), variation of packing density may translate into differential shrinkage of the 3D part, causing warping or cracking of parts. As such, uniform and consistent powder bed packing density may be useful for predicting shrinkage and enabling tight tolerances of final part geometry.

According to an example embodiment, a system and corresponding method for additive manufacturing of a 3D object (also referred to herein as a 3D part or 3D printed part) improve uniformity of powder packing density of a powder bed used in the manufacturing process. An example embodiment of the system comprises means for rotating at least one compaction roller in a first direction to produce a compacted amount of unbound powder metered onto a top surface of a powder bed and means for rotating the at least one compaction roller in a second direction, opposite of the first direction, to compact (e.g., compress, condense, densify, pack down, press down) the compacted amount further, to enable higher density packing of the powder. Such higher density packing leads to better mechanical interlocking of particles, leading to lower sintering temperatures and reduced deformation of the 3D object during sintering. The substantially uniform packing density enables uniform shrinkage, without warping, of the 3D object during sintering to produce higher quality 3D printed objects.

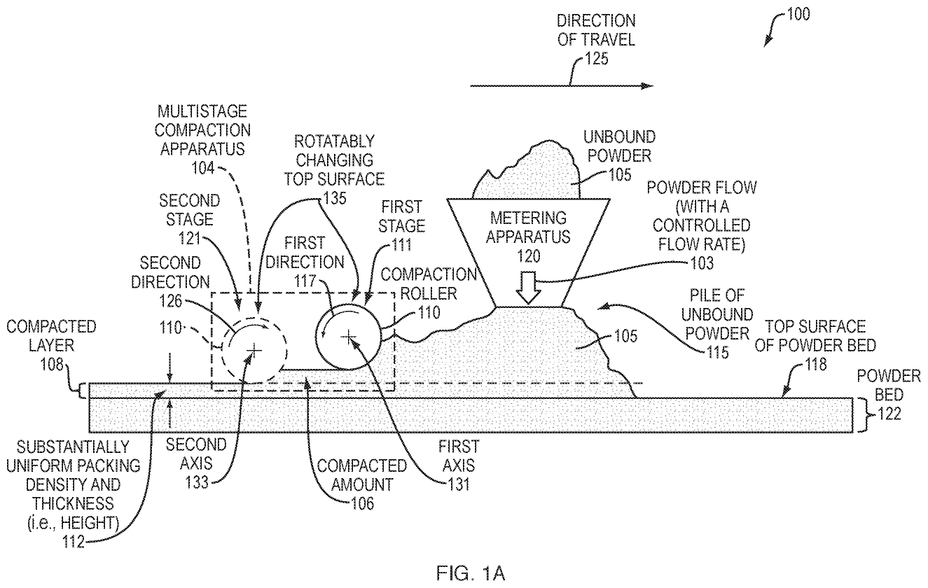

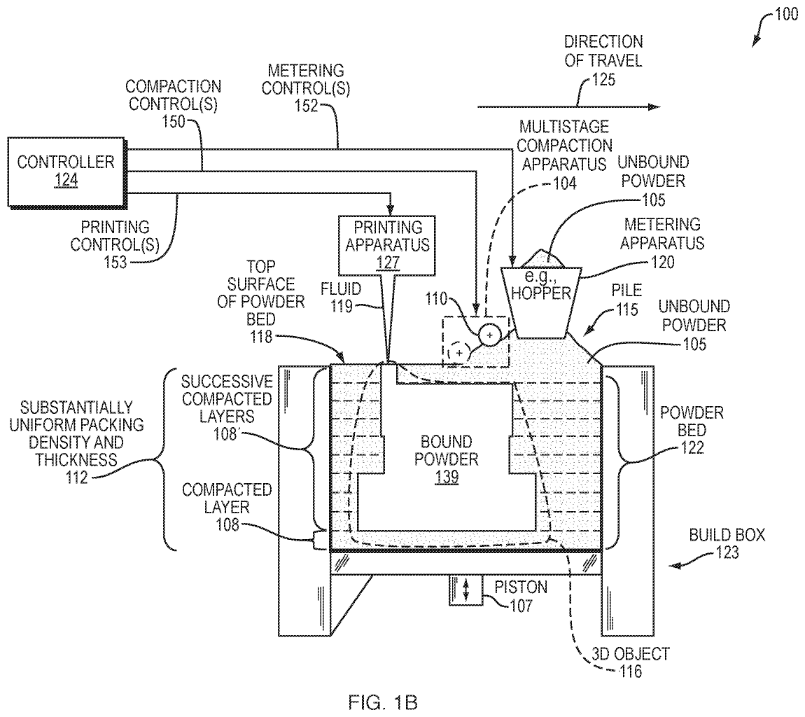

FIG. 1A is a block diagram of an example embodiment of a portion of a system 100 of FIG. 1B for additive manufacturing of a 3D object (not shown). The system 100 of FIG. 1B is disclosed further below with reference to a metal binder jetting printing application. It should be understood that embodiments disclosed herein are not limited to a metal binder jetting printing application and may have application in other binder jetting applications, such as ceramic binder jetting and plastic binder jetting applications, laser-based additive manufacturing applications, such as direct metal laser sintering (DMLS), or any other additive manufacturing application in which powder is spread layer-by-layer.

The portion of the system 100 of FIG. 1A comprises a multistage compaction apparatus 104 and a metering apparatus 120. The metering apparatus 120 may be configured to meter a powder flow 103 of unbound powder 105 with a controlled flow rate onto a top surface 118 of the powder bed 122. The multistage compaction apparatus 104 includes at least one compaction roller 110. According to the example embodiment, the at least one compaction roller 110 may be configured, in a first stage 111, to rotate in a first direction 117 to produce a compacted amount 106 of unbound powder 105 that is metered onto a top surface 118 of a powder bed 122. In a second stage 121, the at least one compaction roller 110 may be configured to rotate in a second direction 126, opposite the first direction 117, to compact the compacted amount 106 further and form a compacted layer 108 of the unbound powder 105 with substantially uniform packing density and thickness 112 across the top surface 118 of the powder bed 122. The substantially uniform packing density and thickness 112 may be substantially uniform within a tolerance such as, ±1%, ±5%, ±10%, or within any other suitable tolerance that may depend on a particular application or parameter. For example, the substantially uniform packing density may be considered to be substantially uniform based on amount of void space of the compacted layer 108 being within a tolerance, such as, ±1%, ±5%, ±10%, or within any other suitable tolerance, of a void space threshold, the void space including voids between particles composing the compacted layer 108. The substantially uniform thickness may be considered to be substantially uniform based on a height of the compacted layer 108 being within a tolerance, such as, ±1%, ±5%, ±10%, or within any other suitable tolerance, of a target height for the compacted layer 108 along a length of the compacted layer 108.

A printing apparatus, such as the printing apparatus 127 of FIG. 1B, disclosed further below, may be configured to jet fluid (not shown) into the compacted layer 108. A controller, such as the controller 124 of FIG. 1B, disclosed below, may be configured to drive the multistage compaction apparatus 104 to produce the compacted layer 108 and successive compacted layers (not shown) of the powder bed 122 with the substantially uniform packing density and thickness 112 and may be configured to drive the printing apparatus to jet fluid into compacted layers of the powder bed 122 to print a 3D object, such as the 3D object 116 of FIG. 1B, disclosed further below. The substantially uniform packing density and thickness 112 may be substantially uniform along an x, y, or z-axis, or a combination thereof.

The unbound powder 105, also referred to interchangeably herein as a powder or a powder material, is metered by the metering apparatus 120. The metering apparatus 120 may be configured to meter the unbound powder 105 onto the top surface 118 of the powder bed 122. The metering apparatus 120 may be any suitable metering apparatus, such as a hopper, or any other suitable metering apparatus configured to meter the unbound powder 105 onto the top surface 118 of the powder bed 122. According to the example embodiment, the multistage compaction apparatus 104 is configured to spread and densify a pile 115 of the unbound powder 105, that is metered onto the top surface 118 of the powder bed 122, via the first stage 111 followed by the second stage 121. The multistage compaction apparatus 104 may be configured to perform the first stage 111 and the second stage 121 to produce the compacted layer 108 with the substantially uniform height and thickness 112. The first stage 111 and the second stage 121 may be referred to interchangeably herein as the first compaction stage 111 and the second compaction stage 121 that may be stages of compaction performed by the compaction apparatus 104.

According to an example embodiment, the controller may be configured to drive the at least one compaction roller 110 to rotate in the first direction 117 to cause an active motion of the unbound powder 105, metered onto the top surface 118 of the powder bed 122, to compact itself and produce the compacted amount 106. For example, the multistage compaction apparatus 104 may be configured to traverse the top surface of the powder bed 122 in a direction of travel 125. In the first stage 111 of compaction, the at least one compaction roller 110 may contact the pile 115 of unbound powder 105. Since the at least one compaction roller 110 is rotating in the first direction 117, such contact of the at least one compaction roller 110 with the unbound powder 105 causes active motion of the unbound powder 105. Such active motion causes the unbound powder 105 to compact itself and produce the compacted amount 106 that may be compacted further in the second stage 121 of compaction performed by the multistage compaction apparatus 104.

The at least one compaction roller 110 that is configured to perform the second stage 121 of compaction may be a same or different compaction roller from the at least one compaction roller 110 that is configured to perform the first stage 111 of compaction. In the second stage 121 of compaction, that may be performed subsequent to the first stage 111 of compaction, the at least one compaction roller 110 is configured to rotate in the second direction 126 and contact the compacted amount 106 produced via the first stage 111 of compaction. The compacted amount 106 may be produced ahead of the at least one compaction roller 110 that is configured to perform the second stage 121. For example, the compacted amount 106 is produced ahead of the at least one compaction roller 110 configured to perform the second stage 121, in the direction of travel 125. By driving the at least one compaction roller 110 to rotate in the second direction 126, that is opposite the first direction 117, the at least one compaction roller 110 applies a downward pressure to compress the compacted amount 106 and compacts the compacted amount 106 further.

As disclosed above, the at least one compaction roller 110 that is configured to perform the second stage 121 of compaction may be a same or different compaction roller from the at least one compaction roller 110 that is configured to perform the first stage 111 of compaction. For example, the at least one compaction roller 110 may be a single compaction roller. The single compaction roller may be configured to traverse the top surface 118 of the powder bed 122 such that the single compaction roller contacts the unbound powder 105 metered onto the top surface 118 of the powder bed 122 and causes active motion of the unbound powder 105 such that the unbound powder 105 compacts itself to produce the compacted amount 106.

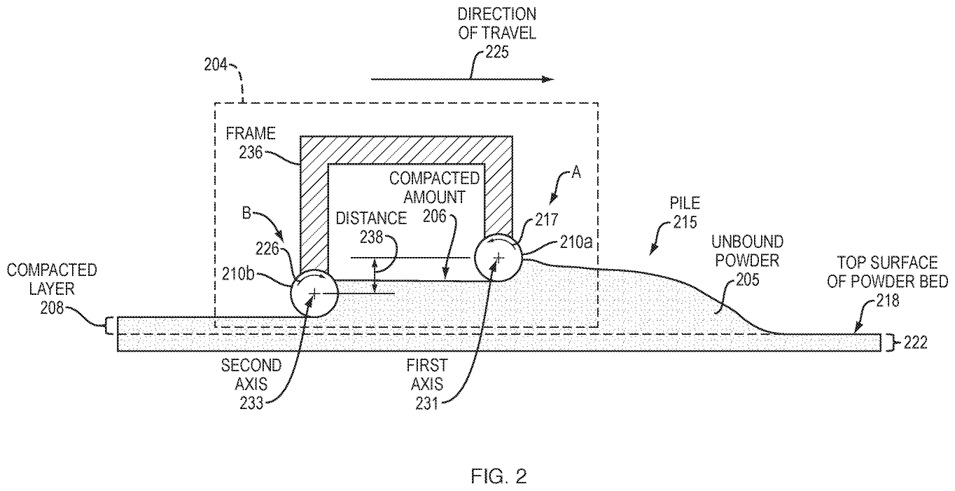

Such active motion may be caused by configuring the single compaction roller to rotate in the first direction 117. Subsequent to producing the compacted amount 106, the single compaction roller may be relocated and positioned such that the single compaction roller traverses the compacted amount 106 while rotating in the second direction 126, opposite the first direction 117. By rotating in the second direction 126, the single compaction roller may apply a downward pressure to the compacted amount 106 and compact the compacted amount 106 further. As such, the first and second stages may be activated sequentially. In the first stage 111, the single compaction roller may be positioned at a location A, such as the location A of FIG. 2, disclosed further below, and repositioned to a location B, such as the location B of FIG. 2, that is closer to the top surface 118 of the powder bed relative to location A.

According to an example embodiment, the at least one compaction roller 110 that is configured to perform the second stage 121 of compaction may be different from the compaction roller 110 that is configured to perform the first stage 111 of compaction. For example, the at least one compaction roller 110 may include a first compaction roller and a second compaction roller, such as the first compaction roller 210a and second compaction roller 210b of FIG. 2, disclosed further below. In the first stage 111, the controller may be configured to drive the first compaction roller to rotate in the first direction 117.

Following the first stage 111, in which the first compaction roller rotates in the first direction 117 to cause active motion of the unbound powder 105 to cause the unbound powder 105 to compact itself and produce the compacted amount 106, the controller may, in the second stage 121, drive the second compaction roller to rotate in the second direction 126. The second direction 126 may be opposite the first direction 117 to enable the second compaction roller to apply the downward pressure to the compacted amount 106 to compact the compacted amount further.

As the multistage compaction apparatus 104 traverses the top surface 118 of the powder bed 122, the first compaction roller may be rotating in the first direction 117 while the second compaction roller is rotating, simultaneously, in the second direction 126, opposite of the first direction 117. As such, the first stage 111 and the second stage 121 may be activated concurrently, as the multistage compaction apparatus 104 traverses the top surface 118 of the powder bed 122 in the direction of travel 125. It should be understood that the direction of travel 125 is for illustrative purposes and that the direction of travel 125 may be any suitable direction of travel relative to the top surface 118 of the powder bed 122.

The system 100 may further comprise a motor (not shown). The controller, such as the controller 124 of FIG. 1B, disclosed further below, may be configured to, in the first stage 111, drive the motor to cause the at least one compaction roller 110 to rotate in the first direction 117 to cause the at least one compaction roller 110 to slip, relative to the unbound powder 105 metered onto the top surface 118 of the powder bed 122, and cause the active motion of the unbound powder 105 such that the unbound powder 105 compacts itself and produces the compacted amount 106.

In the second stage 121, the controller may be configured to drive the motor to cause the at least one compaction roller 110 to rotate in the second direction 126, opposite the first direction 117, to cause the at least one compaction roller 110 to spin, such that there is no slip of the at least one compaction roller 110 relative to the compacted amount 106, to cause the at least one compaction roller 110 to apply the downward pressure to the compacted amount 106.

The controller may be further configured, in the first stage 111, to drive the at least one compaction roller 110 to rotate in the first direction 117 around a first axis 131. In the second stage 111, the controller may be configured to drive the at least one compaction roller 110 to rotate in the second direction 126 around a second axis 133. The first axis 131 may be located at a distance above the second axis 133, as disclosed further below with reference to FIG. 2. Such a distance may be controlled by the controller to control the packing density of the compacted layer 108. Adjustment of the distance may be performed by the controller based on feedback, such as a sensed packing density or height of the compacted amount 106, or may be based on any other suitable feedback.

The controller may be further configured, in the first stage 111 and the second stage 121, to drive the multistage compaction apparatus 104 to traverse the top surface 118 of the powder bed 122 in the direction of travel 125. In the first stage 111, the controller may be configured to drive rotation of the at least one compaction roller 110 such that a rotatably changing top surface 135 of the at least one compaction roller 110 is configured to rotate opposite the direction of travel 125, that is, in the first direction 117. Rotation of the rotatably changing top surface opposite the direction of travel may be referred to interchangeably herein as “reverse rolling.” The controller may be further configured, in the second stage, to drive rotation of the at least one compaction roller 110 such that the rotatably changing top surface 135 is configured to rotate in the direction of travel 125, that is, in the second direction 126. A position of the at least one compaction roller 110 employed in the first stage 111 and the second stage 121 may be adjusted by a controller, such as the controller 124 of FIG. 1B, disclosed below.

FIG. 1B is a block diagram of an example embodiment of the system 100 for additive manufacturing of a three-dimensional (3D) object 116. The system 100 comprises the controller 124, metering apparatus 120 (also referred to interchangeably herein as a powder dispensing apparatus, metering apparatus, or powder metering apparatus), multistage compaction apparatus 104, and a printing apparatus 127. It should be understood that the printing apparatus 127 may be composed of multiple printheads. The system 100 may include a build box 123 for housing the powder bed 122. The powder bed 122 may be supported by a piston 107, or any other suitable supporting structure for the powder bed 122 that may be configured to move down within the build box 123 such that subsequent layers of the powder bed 122 may be formed. It should be understood that a top surface of the piston 107 or other suitable supporting structure serves as the top surface 118 of the powder bed 122, initially, and that each layer of powder formed thereafter serves as the top surface 118 of the powder bed 122 as the powder bed 122 grows in depth.

According to an example embodiment, the metering apparatus 120 may be configured to dispense the unbound powder 105 by metering the unbound powder 105 to produce the powder flow 103 with a controlled flow rate. The unbound powder 105 may be referred to interchangeably herein as powder material, build material, feedstock, or simply, powder. The unbound powder 105 may be introduced into the metering apparatus 120 in any suitable manner. The metering apparatus 120 may be a hopper and the unbound powder 105 may be a metallic powder. For example, according to an example embodiment, the metering apparatus 120 may be configured to meter metal injection molding (MIM) metal powder into a pile with a height, for example, as small as 30 microns, onto the top surface 118 of the powder bed 122. The metering apparatus 120 may dispense the unbound powder 105 at a dispense rate. The multistage compaction apparatus 104 may traverse the top surface 118 of the powder bed 122 at a traversal rate. The pile 115 of the powder material 105 may be formed as a function of a difference between the dispense rate and the traversal rate.

The pile 115 may be compacted by the multistage compaction apparatus 104 for an even distribution, that is, a substantially uniform height (also referred to interchangeably herein as thickness) and substantially uniform packing density, to form the compacted layer 108 of the metal powder via the first stage 111 and the second stage 121, as disclosed above. The multistage compaction apparatus 104 may be configured to spread and densify the pile 115. The substantially uniform packing density may be referred to interchangeably herein as uniform density and may be substantially uniform in directions along an x, y, or z-axis, or a combination thereof. According to an example embodiment, the packing density of the compacted layer 108 and successive compacted layers 108′, may be controlled by controlling a distance between the at least one compaction roller 110 in the first stage 111 and the second stage 121, as disclosed further below with reference to FIG. 2.

A height of the compacted pile 106 may be sensed by a sensor device (not shown) and the height sensed may be communicated to the controller 124 and may serve as compaction feedback (not shown) that may be employed by the controller 124 to control the compaction apparatus 104, and metering apparatus 120, via the compaction control(s) 150, and metering control(s) 152, respectively.

The controller 124 may be configured to control the metering apparatus 120, multistage compaction apparatus 104, and the printing apparatus 127 via the compaction control(s) 150, and metering control(s) 152, and printing control(s) 153, respectively. For example, the controller 124 may be configured to control a metering rate of the metering apparatus 120, motion of the metering apparatus 120 across the powder bed 122, motion of the multistage compaction apparatus 104, motion of the at least one compaction roller 110 of the multistage compaction apparatus 104, motion of the printing apparatus 127, release of the fluid 119 from the printing apparatus 127, and a vertical movement of the top surface 118 of the powder bed 122.

The controller 124 may be further configured to actuate the printing apparatus 127 to deliver the fluid 119 from the printing apparatus 127 to each compacted layer of the powder 122 in a controlled two-dimensional pattern as the printing apparatus 127 moves across the top surface 118 of the powder bed 122. Further, the controller 124 may be configured to control position of the metering apparatus 120, multistage compaction apparatus 104, and printing apparatus 127 relative to the top surface 118 of the powder bed 122 as well as respective offsets between respective axes of the metering apparatus 120, multistage compaction apparatus 104, at least one compaction roller 110 of the multistage compaction apparatus 104, and the printing apparatus 127.

The controller 124 may drive the multistage compaction apparatus 104 to traverse the top surface 118 of the powder bed 122 in the direction of travel 125. The controller 124 may drive the metering apparatus 120 to meter the unbound powder 105 onto the top surface 118 of the powder bed 122 ahead of traversal of the multistage compaction apparatus 104 in the direction of travel 125. For example, the controller 124 may assert metering control signal(s) 152 to drive the metering apparatus 120 to produce the powder flow 103 with a controlled flow rate ahead of traversal of the multistage compaction apparatus 104 in the direction of travel 125.

The printing apparatus 127 may employ a plurality of jets to selectively deposit droplets of a fluid 119 to bind the compacted layer 108 of metal powder and the successive compacted layers 108′ to produce the bound powder 139. Such droplets of the fluid 119 may be small, for example, two trillionths of a liter (smallest droplet), and tens of millions of droplets may be deposited per second, binding the compacted layer 108 and successive compacted layers 108′ of the metal powder.

The printing apparatus 127 may be configured to jet the fluid 119 into at least one region of the compacted layer 108 and successive compacted layers 108′. The printing apparatus 127 may include a discharge orifice and, in certain implementations, may be actuated (e.g., through delivery of an electric current to a piezoelectric element in mechanical communication with the fluid 119) to dispense the fluid 119 through the discharge orifice to the compacted layer 108 and successive compacted layers 108′. The fluid 119 may be configured to cause the layer to bind at the at least one region to form a bonded layer of bound powder 139 of the 3D object 116. Heat may be applied to further speed up the binding process and sinter the 3D object 116 to form a final version of the 3D object 116.

It should be appreciated that the movement of the printing apparatus 127 and the actuation of the printing apparatus 127 to deliver the fluid 119 may be done in coordination with movement of the multistage compaction apparatus 104 across the top surface 118 of the powder bed 122. For example, the multistage compaction apparatus 104 may spread and compact a layer of the powder 105 across the top surface 118 of the powder bed 122, and the printing apparatus 127 may deliver the fluid 119 in a controlled two-dimensional pattern to the compacted layer of the powder spread across the top surface 118 of the powder bed 122 to form a bound layer of the 3D object 116. Such operations may be repeated (e.g., with a controlled two-dimensional pattern for each respective layer) in sequence to form subsequent layers until, ultimately, the 3D object 116 is formed in the powder bed 122, such as the powder bed 422 of FIG. 4, disclosed further below.

According to an example embodiment, the metering apparatus 120 and multistage compaction apparatus 104 may be configured to move across the top surface 118 of the powder bed 122 as a unit. The multistage compaction apparatus 104 may be configured to traverse the top surface 118 of the powder bed 122 in a traversal direction 125. The unit may be configured to traverse the top surface 118 of the powder bed 122 in the traversal direction 125 and meter the unbound powder 105 onto the top surface 118 of the powder bed 122 ahead of a traversal by the multistage compaction apparatus 104. According to an example embodiment, the unit may also include the printing apparatus 127 and the printing apparatus 127 may be configured to apply the fluid 119 following the traversal by the multistage compaction apparatus 104 that itself follows traversal by the metering apparatus 120.

According to an example embodiment, the multistage compaction apparatus 104 and the printhead 119 may be configured to traverse the top surface 118 of the powder bed 122 as a unit. The unit may follow traversal by the metering apparatus. The printing apparatus 127 may be configured to apply the fluid 119 following the traversal by the multistage compaction apparatus 104.

According to an example embodiment, the metering, compacting, and jetting operations may be operations that are activated sequentially. According to another example embodiment, at least two of the metering, compacting, and jetting operations may be operations that are activated concurrently.

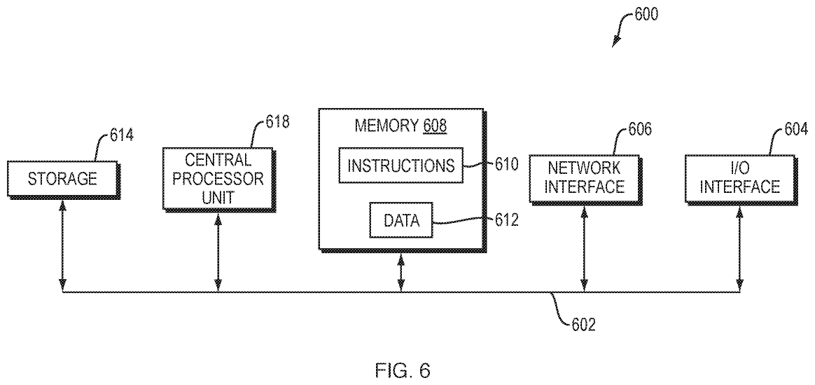

It should be understood that a direction of travel for the metering apparatus 120, multistage compaction apparatus 104, and printing apparatus 127 may be in any suitable direction relative to the top surface 118 of the powder bed 122. Further, such direction may be a uni- or bi-directional. Further, it should be understood that the control of such operations may be performed by the controller 124. The controller 124 may include a processor, such as the central processing unit 618 of FIG. 6, disclosed further below, digital signal processor (DSP), field programmable gate array (FPGA), proportional-integral-derivative (PID) controller, or any other digital or analog controller, combination thereof, or equivalent thereof.

It should be understood that the controller 124 may control the meter, compact, and jet operations such that the operations are performed in an iterative manner. However, such iterations may include performing multiple repetitions of any one operation prior to performing another such that there is not a 1:1 correspondence. For example, the controller 124 may control the operations such as: meter, compact, jet. Alternatively, the controller 124 may control the operations such as: meter . . . meter, compact . . . compact, etc. It should be understood that the controller may control the meter, compact, and jet operations in any suitable manner.

According to an example embodiment, the controller 124 may be configured to receive feedback that may include sensor information, such as sensed height of the pile 115, sensed height of the compacted amount 106, or any other suitable sensor information, such as density of the compacted amount 106, compaction feedback (not shown) from the multistage compaction apparatus 104, metering feedback (not shown) from the metering apparatus 120, or a combination thereof. Such feedback may be employed by the controller 124 to perform closed loop control over the meter, compact, and jet operations.

For example, sensed information regarding height of the pile 115 of unbound powder metered onto the top surface 118 of the powder bed 122, height of the compacted amount 106, etc. may be used by the controller 124 to adjust parameters of the metering apparatus 120, multistage compaction apparatus 104, or a combination thereof. For example, sensed information received by the controller 124 may be employed to control a distance in height between axes of the at least one compaction roller, such as the distance 238 of FIG. 2, disclosed further below, or speed of rotation of the first direction 117 and the second direction 126. The parameters adjusted may include position of the at least one compaction roller 110, rate of traversal, rate of dispensing, or any other suitable parameter or combination of parameters. Sensing the height may include obtaining the height from a sensor device (not shown). Alternatively, the height may be sensed based on feedback regarding torque, drive current, rotational speed, etc. of the multistage compaction apparatus 104.

The compaction feedback may include information regarding rotational speed, acceleration, velocity, torque, an amount of electrical current being employed to drive rotation of the at least one compaction roller 110, or any other suitable information of the multistage compaction apparatus 104. The compaction feedback may be used by the controller 124 to adjust a parameter of the metering apparatus 120, multistage compaction apparatus 104, or a combination thereof. The parameter adjusted may include an offset in height or other position of the at least one compaction roller 110 or the top surface 118 of the powder bed 122, or any other suitable parameter.

According to an example embodiment, the compaction feedback may be employed by the controller 124 to determine a level (i.e., degree) of uniformity of the compacted amount 106 and may be configured to adjust the metering apparatus 120, multistage compaction apparatus 104, or a combination thereof based on the level of uniformity determined. For example, the controller 124 may adjust height of the at least one compaction roller 110 in the first stage 111, the second stage 121, or a combination thereof, speed of rotation of the first direction 117, the second direction 126, or a combination thereof, traversal rate of the multistage compaction apparatus 104, etc.

FIG. 2 is a block diagram of an example embodiment of a multistage compaction apparatus 204. The multistage compaction apparatus 204 includes a first compaction roller 210a and a second compaction roller 210b that are positioned relative to the top surface 218 of the powder bed 222 via an adjustable frame 236. In a first stage compaction stage performed by the multistage compaction apparatus 204, a controller, such as the controller 124 of FIG. 1B, disclosed above, may be configured to drive the first compaction roller 210a to rotate in a first direction 217 around a first axis 231. In a second stage of compaction of the multistage compaction apparatus 204, the controller may be configured to drive the second compaction roller 210b to rotate in the second direction 226 around a second axis 233.

The first axis 231 may be located at a distance 238 that may be above the second axis 233. The distance 238 may be configured based on a particle size of particles of the unbound powder 205. The distance 238 may be configured to be less than a diameter of the first compaction roller 210a that is configured to rotate in the first direction 231 in the first stage of compaction. The distance 238 may be adjustable and controlled by a controller, such as the controller 124 of FIG. 1B, disclosed above, to control the packing density of the compacted layer 208.

The first compaction roller 210a may be driven to rotate in the first direction 217 to cause an active motion of the unbound powder 205, metered onto the top surface 218 of the powder bed 222, to compact itself and produce the compacted amount 206. For example, the multistage compaction apparatus 204 may be configured to traverse the top surface of the powder bed 222 in a direction of travel 225. In the first stage of compaction, the first compaction roller 210a contacts the pile 215 of unbound powder 205 metered onto the top surface 218 of the powder bed 222 prior to the second compaction roller 210b.

Since the first compaction roller 210a rotates in the first direction 217 in the first stage, such contact of the first compaction roller 210 with the unbound powder 205 causes active motion of the unbound powder 205. The active motion causes the unbound powder 205 to compact itself and produce the compacted amount 206 that may be compacted further in the second stage of compaction to form the compacted layer 208 of the unbound powder 205 with substantially uniform packing density and thickness 212 across the top surface 218 of the powder bed 222.

The first compaction roller 210a may be a same or different compaction roller from the second compaction roller 210b. For example, the first compaction roller 210a may be repositioned from position A to position B to perform the second stage of compaction. In the first stage, the first compaction roller 210a may be positioned at a location A and repositioned to location B, that is closer to the top surface 118 of the powder bed relative to location A. In position B, the first compaction roller 210a may be driven to rotate in the second direction 226, that is opposite the first direction 217, and apply downward pressure to compress the compacted amount 206 and compact the compacted amount 206 further.

Alternatively, the first compaction roller 210a and the second compaction roller 210b may be different compaction rollers. In the second stage of compaction, the second compaction roller 210b may be configured to rotate in the second direction 226, opposite the first direction 217, and contact the compacted amount 206 that is produced via the first stage 217 of compaction. By driving the second compaction roller 210b to rotate in the second direction 226, that is opposite the first direction 217, the second compaction roller 210 applies a downward pressure to compress the compacted amount 206 and compact the compacted amount 206 further.

In the first stage, the first compaction roller 210a may be configured to rotate in the first direction 217 to be caused to slip, relative to the unbound powder 205 metered onto the top surface 218 of the powder bed 222, and cause the active motion of the unbound powder 205 to compact itself. In the second stage, the second compaction roller 210b may be configured to rotate in the second direction 226, opposite the first direction 217, to cause the second compaction roller 210b to spin, such that there is no slip of the second compaction roller 210b relative to the compacted amount 206, to apply the downward pressure to the compacted amount 206. As such, in the first stage of compaction, the multi-stage compaction apparatus provides some compaction and in the second stage, the multi-stage compaction apparatus provides final compaction of the powder pile 215 to form the compacted layer 208 with substantially uniform packing density and thickness.

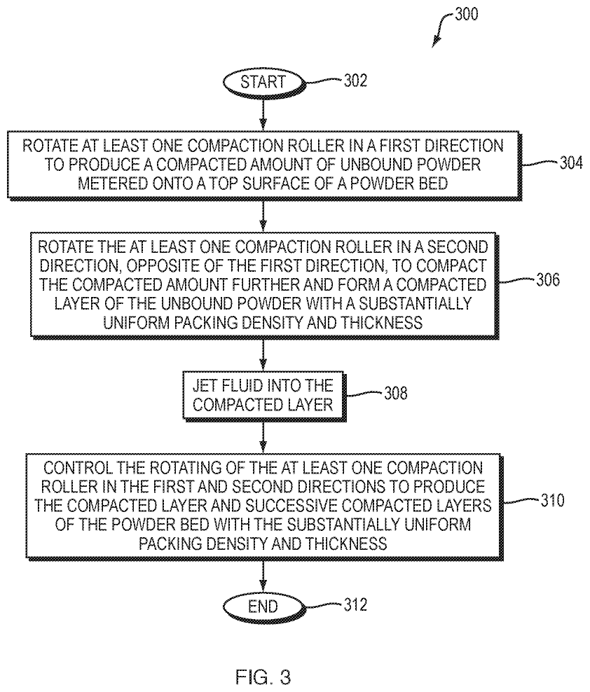

FIG. 3 is a flow diagram 300 of an example embodiment of a method for additive manufacturing of a 3D object. The method begins (302) and rotates at least one compaction roller in a first direction to produce a compacted amount of unbound powder metered onto a top surface of a powder bed (304). The method rotates the at least one compaction roller in a second direction, opposite of the first direction, to compact the compacted amount further and form a compacted layer of the unbound powder with a substantially uniform packing density and thickness across the top surface of the powder bed (306). The method jets fluid into the compacted layer (308) and controls the rotating of the at least one compaction roller in the first and second directions to produce the compacted layer and successive compacted layers of the powder bed with the substantially uniform packing density and thickness and controls the jetting of the fluid into compacted layers of the powder bed to print the 3D object (310), and the method thereafter ends (312), in the example embodiment.

FIG. 4 is a block diagram of an example embodiment of a powder bed 422. According to the example embodiment, the powder bed 422 may be supported by a piston 407 and surrounded by walls of a build box 423. The piston 407 may have any suitable shape, such as a square or circular shape, or any other suitable shape. The piston 407 may be configured to move within the build box 423 in a direction downward following application of the fluid 419 by the printhead 427. The powder bed 422 may be heated to dry the fluid 419 and to maintain flowability of the unbound powder 405. The powder bed 422 may be heated in any suitable way to heat the three-dimensional object 416 in the powder bed 422 to a target temperature. It should be understood that the while the build box 423 may be referred to as a “box,” the build box 423 may be a housing of any suitable shape for containing the piston 407 and the powder bed 422. As disclosed above, operations may be repeated (e.g., with a controlled two-dimensional pattern for each respective layer) in sequence to form subsequent layers until, ultimately, the 3D object 416 may be formed in the powder bed 422.

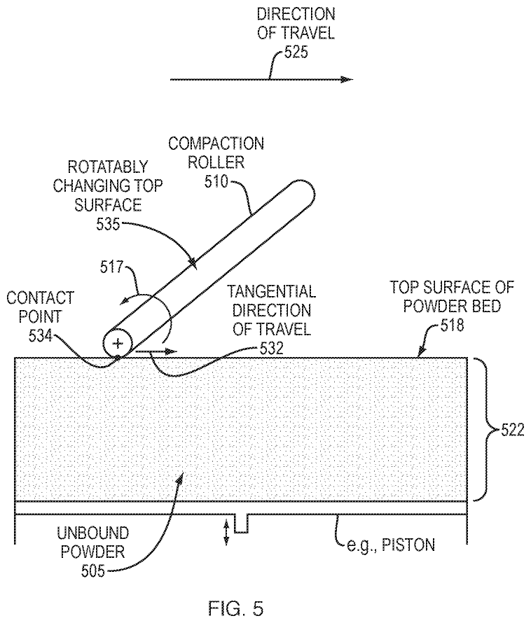

FIG. 5 is a block diagram of an example embodiment of a compaction roller 510 and a tangential direction of travel 532. In the example embodiment, the compaction roller 510 is configured to traverse the top surface 518 of the powder bed 522 in a direction of travel 525. The compaction roller 510 is further configured to rotate in a direction 517 such that, at a contact point 534 between the roller compaction roller 510 and the top surface 518 of the powder bed 522, a tangential direction of travel 532 of the contact point 534 with the top surface 518 of the powder bed 522 is in a same direction as traversal of the compaction roller 510. That is, the tangential direction of travel 532 of the contact point 534 is in the same the direction of travel 525 of the compaction roller 510 across the top surface 518 and is in a same direction of spreading of the unbound powder 505 by the compaction roller 510.

In such a rotational configuration, a rotatably changing top surface 535 of the compaction roller 510 is configured to rotate opposite the direction of travel 525. As such, the compaction roller 510 may be understood as rolling in reverse of the direction of travel 525 and may be referred to as a “reverse” or a “counter-rotating” roller. Rotation of the compaction roller 510 in a direction that is opposite to the direction 517 may be understood as rolling in a same direction as the direction of travel 525 since such an opposite direction causes the rotatably changing top surface 535 to move in a direction that is in a same direction as the direction of travel 525. Such a compaction roller that has the rotatably changing top surface 535 configured to move in a direction that is in a same direction as the direction of travel 525 may be referred to herein as a “forward roller.”

Turning back to FIG. 1A, the at least one compaction roller 110 that is configured to rotate in the first direction 117 in the first stage 111, may be referred to as being a “reverse” roller, whereas the at least one compaction roller 110 that is configured to rotate in the second direction 126 in the second stage 121, that is, in a direction opposite the first direction 117 employed in the first stage 111, may be referred to as a “forward” roller since rotation of the rotatably changing surface 135 is in a same direction as the direction of travel 125.

FIG. 6 is a block diagram of an example of the internal structure of a computer 600 in which various embodiments of the present disclosure may be implemented. The computer 600 contains a system bus 602, where a bus is a set of hardware lines used for data transfer among the components of a computer or processing system. The system bus 602 is essentially a shared conduit that connects different elements of a computer system (e.g., processor, non-volatile storage, memory, input/output ports, network ports, etc.) that enables the transfer of information between the elements. Coupled to the system bus 602 is an I/O device interface 604 for connecting various input and output devices (e.g., keyboard, mouse, displays, printers, speakers, etc.) to the computer 600. A network interface 606 allows the computer 600 to connect to various other devices attached to a network. Memory 608 provides volatile storage for computer software instructions 610 and data 612 that may be used to implement embodiments of the present disclosure. Disk or flash memory storage 614 provides non-volatile storage for computer software instructions 610 and data 612 that may be used to implement embodiments of the present disclosure. A central processor unit 618 is also coupled to the system bus 602 and provides for the execution of computer instructions.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 6, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

Further, example embodiments and elements thereof may be combined in a manner not explicitly disclosed herein.

While example embodiments have been particularly shown and described, it will be understood by those skilled in the art that various changes in form and details may be made therein without departing from the scope of the embodiments encompassed by the appended claims.

1-26. (canceled)

27. A system for additive manufacturing of a three-dimensional object, the system comprising:
a compaction apparatus including at least one roller, wherein the at least one roller is configured, in a first stage, to rotate in a first direction across powder on a top surface of a powder bed and, in a second stage, to rotate in a second direction, opposite to the first direction, across the powder on the top surface of the powder bed; and
a printing apparatus configured to deliver binder fluid to the powder on the top surface of the powder bed.

28. The system of claim 27, further comprising a metering apparatus configured to deliver the powder onto the top surface of the powder bed.

29. The system of claim 28, wherein the metering apparatus is oriented upstream of the compaction apparatus in a direction of travel over the powder bed, and wherein the printing apparatus is oriented downstream of the compaction apparatus in the direction of travel over the powder bed.

30. The system of claim 29, further comprising a controller configured to move the compaction apparatus across the powder in contact with the top surface of the powder bed in the direction of travel and to move the printing apparatus across the powder on the top surface of the powder bed in the direction of travel to deliver the binder fluid onto the powder on the powder bed to print the object.

31. The system of claim 30, wherein the controller is further configured to move the metering apparatus to deliver the powder onto the top surface of the powder bed upstream of the compaction apparatus in the direction of travel.

32. The system of claim 30, wherein the at least one roller of the compaction apparatus is configured to compact the powder on the top surface of the powder bed.

33. The system of claim 30, wherein the at least one roller is a single roller.

34. The system of claim 33, wherein the controller is configured to move the single roller across the powder on the top surface of the powder bed a first time with the single roller rotating in the first direction, and wherein the controller is configured to move the single roller across the powder on the top surface of the powder bed a second time with the single roller rotating in the second direction.

35. The system of claim 27, further comprising a motor configured to move the at least one roller,
wherein, when in the first stage, the motor moves the at least one roller to rotate in the first direction to slip relative to the powder on the top surface of the powder bed, and
wherein, when in the second stage, the motor moves the at least one roller to rotate in the second direction to spin, such that there is no slip of the at least one roller relative to the powder on the top surface of the powder bed, to apply a downward pressure to the powder.

36. The system of claim 27, wherein the at least one roller includes a first roller that rotates in the first direction and a second roller that rotates in the second direction.

37. The system of claim 36, wherein the first roller is oriented upstream of the second roller in a direction of travel across the top surface of the powder bed.

38. The system of claim 37, wherein the second roller is parallel to the first roller.

39. The system of claim 38, wherein the first roller is spaced away from the top surface of the powder bed by a first distance, and wherein the second roller is spaced away from the top surface of the powder bed by a second distance.

40. The system of claim 39, wherein the first distance is greater than the second distance by a height difference along a z axis.

41. The system of claim 40, wherein the height difference is less than a diameter of the first roller.

42. A system for additive manufacturing of a three-dimensional object, the system comprising:
a compaction apparatus including a first roller and a second roller, wherein the first roller is configured to rotate in a first direction across powder on a top surface of a powder bed, and wherein the second roller is configured to rotate in a second direction, opposite to the first direction, across the powder on the top surface of the powder bed.

43. The system of claim 42, further comprising a controller configured to move the compaction apparatus across the powder on the top surface of the powder bed in a direction of travel.

44. The system of claim 43, further comprising:
a metering apparatus configured to deliver the powder onto the top surface of the powder bed; and
a printing apparatus configured to deliver binder fluid to the powder on the top surface of the powder bed,
wherein the metering apparatus is located upstream of the compaction apparatus in a direction of travel over the powder bed, and wherein the printing apparatus is located downstream of the compaction apparatus in the direction of travel over the powder bed.

45. The system of claim 44, wherein the controller is further configured to move the metering apparatus to deliver the powder onto the top surface of the powder bed upstream of the compaction apparatus in the direction of travel, and to move the printing apparatus across the top surface of the powder on the powder bed to deliver the binder fluid onto the powder on the powder bed to print the object.

46. The system of claim 42, wherein the second roller is parallel to the first roller, and wherein the first roller is located upstream of the second roller in a direction of travel across the powder on the top surface of the powder bed.

47. The system of claim 42, wherein the first roller is spaced away from the top surface of the powder bed by a first distance, and wherein the second roller is spaced away from the top surface of the powder bed by a second distance.

48. The system of claim 47, wherein the first distance is greater than the second distance by a height difference along a z axis.

49. The system of claim 48, wherein the height difference is less than a diameter of the first roller.

50. The system of claim 47, wherein at least one of the first distance or the second distance is adjustable.

51. A method for additive manufacturing of a three-dimensional object, the method comprising:
depositing powder onto a top surface of a powder bed;
rotating a first roller in a first direction across the powder on the top surface of the powder bed to compact the powder;
rotating a second roller in a second direction, opposite to the first direction, across the powder on the top surface of the powder bed to further compact the powder; and
delivering a binder fluid onto the powder on the top surface of the powder bed.

52. The method of claim 51, wherein the first direction is opposite to a direction of travel of the first roller such that, at a contact point between the first roller and the powder on the top surface of the powder bed, a tangential direction of travel at the contact point between the first roller and the powder on the top surface of the powder bed is in the same direction as the direction of travel of the first roller, and
wherein the second direction is in the same direction as a direction of travel of the second roller such that, at a contact point between the second roller and the powder on the top surface of the powder bed, a tangential direction of travel at the contact point between the second roller and the powder on the top surface of the powder bed is in an opposite direction as the direction of travel of the second roller.
